(19) United States
(12) Patent Application Publication
(10) Pub. No.: US 2026/0346277 A1
(43) Pub. Date: Nov. 5, 2026

(54) COMBINATION SHOWERHEAD AND VENTILATION APPRATUS

(71) Applicant: D.Ellinas Factory Products Ltd, Mouttagiaka (CY)

(72) Inventor: Dimitrakis Ellinas, Mouttagiaka (CY)

(73) Assignee: D.Ellinas Factory Products Ltd, Mouttagiaka (CY)

(21) Appl. No.: 19/643,105

(22) Filed: Apr. 9, 2026

Related U.S. Application Data
(60) Provisional application No. 63/785,725, filed on Apr. 9, 2025.

(51) Int. Cl. B05B 1/18

(52) U.S. Cl. CPC B05B 1/18

(57) ABSTRACT

A showerhead and air ventilation apparatus is disclosed. The apparatus includes a water pathway configured to receive water through a water inlet port, distribute the water within a water distribution chamber, and discharge the water through a plurality of spouts. The apparatus further comprises a separate ventilation air pathway configured to receive humid air from a shower area through an air inlet port, direct the air through an air exhaust chamber, and discharge the air through an air exhaust port to an external environment or downstream processing system.

### CROSS-REFERENCE TO RELATED APPLICATIONS

This disclosure claims priority from U.S. Provisional Patent Application No. 63/785,725, filed on Apr. 9, 2025, the disclosure of which is incorporated herein by reference in its entirety.

### TECHNICAL FIELD

The aspects of the disclosed embodiments relate to showerhead devices and ventilation systems, and more particularly to a combined showerhead and air-ventilation apparatus.

### BACKGROUND

Showerhead devices and ventilation systems are known. Showerheads are commonly used to provide a water spray for bathing, while ventilation systems are used to remove humid air generated within the confined environment of a shower or bathroom.

Various showerhead devices combine water delivery with additional functions, such as soap dispensing, water filtering, water conditioning, and massage features. Likewise, ventilation systems may incorporate secondary functions such as air filtering, dehumidifying, and lighting. However, there remains a need for a device that integrates water spraying and air ventilation functions into a single apparatus.

Integrating both functions into a single apparatus may provide various advantages. For example, humid air may be removed directly from the shower area before spreading into the surrounding bathroom environment, thereby reducing moisture-related effects such as residue accumulation, mold development, and fogging of nearby surfaces. In addition, localized ventilation may permit the use of lower-capacity and lower-noise airflow systems. Accordingly, it would be desirable to provide an apparatus that addresses at least some of the issues described above.

### SUMMARY

The aspects of the disclosed embodiments are directed to a combination showerhead and air ventilation apparatus that integrates water spraying and air ventilation functions into a single device. In some embodiments, air, such as humid air, is removed directly from the shower area, which may reduce moisture spread and improve ventilation efficiency. Additional aspects and features of the disclosed subject matter are set forth in the following description and claims.

According to a first aspect, the above and further aspects and advantages are obtained by an apparatus. In one embodiment, the apparatus is a combination showerhead and air-ventilation apparatus that includes a housing comprising a water inlet port, an air inlet port, a plurality of water spouts, and an air exhaust port; a water distribution chamber disposed within the housing and configured to receive water from the water inlet port and distribute the water to the plurality of water spouts; and an air exhaust chamber disposed within the housing and configured to receive humid air from the air inlet port and direct the humid air to the air exhaust port. The water distribution chamber and the air exhaust chamber are in fluid isolation from one another within the housing. This arrangement permits water delivery and air evacuation to be performed within a single integrated device.

In a possible implementation form, the apparatus includes an air pressure deficit generating system in fluid communication with the air exhaust port. This may facilitate active removal of humid air from the shower area.

In a possible implementation form, the apparatus includes a top cover, a diaphragm, and a shower plate, and wherein the air exhaust chamber is formed in a space between the top cover and the diaphragm. This may provide a compact stacked construction for the air flow path.

In a possible implementation form, the water distribution chamber is formed in a space between the diaphragm and the shower plate. This may allow the water flow path to be separated from the air flow path by the diaphragm.

In a possible implementation form, the air inlet port is a peripheral gap formed between lateral walls of the diaphragm and shower plate and lateral walls of the top cover. This may allow humid air to be collected around a perimeter region of the apparatus.

In a possible implementation form, the diaphragm comprises a diaphragm plate and a plurality of support columns extending from a top surface of the diaphragm plate to a bottom surface of the top cover. The support columns maintain a separation distance between the top cover and the diaphragm plate to define the air exhaust chamber. This may provide structural support while maintaining the air flow volume.

In a possible implementation form, the water distribution chamber is defined by a recessed pocket formed on a top surface of the shower plate. The recessed pocket is enclosed by a bottom surface of the diaphragm. This may provide controlled distribution of water to the plurality of water spouts.

In a possible implementation form, the apparatus is a ceiling-mounted unit and the water inlet port and air exhaust port are located on a top surface of the housing. This may facilitate concealed connection to water supply and ventilation infrastructure above a ceiling.

In a possible implementation form, the apparatus is a wall-mounted unit. This may allow installation in shower environments where ceiling mounting is not preferred or available.

In a possible implementation form, the water inlet port and the air exhaust port are located on a rear surface of the housing for lateral connection through a wall. This may permit simplified routing of water and ventilation connections within a wall cavity.

In a possible implementation form, the air inlet port is located on a top, bottom, or side surface of the housing. This may provide flexibility in adapting the apparatus to different mounting configurations.

In a possible implementation form, the apparatus is a handheld unit further comprising a handle coupled to the housing. This may allow the apparatus to be manually positioned by a user during operation.

In a possible implementation form, the apparatus includes an integrated light fixture. This may improve visibility within the shower area.

In a possible implementation form, the apparatus includes an integrated water filter disposed within the water distribution chamber or upstream thereof. This may improve water quality delivered through the plurality of water spouts.

In a possible implementation form, the apparatus includes an integrated soap dispensing feature. This may reduce the need for separate shower accessories.

According to a second aspect the above and further aspects and advantages are obtained by an apparatus. In one embodiment, the apparatus is a ceiling-mounted shower and ventilation system that includes a support frame defining a through-hole and configured for installation within an opening in a ceiling structure. The support frame includes an inner support step. A showerhead assembly removably rests on the inner support step of the support frame. The assembly has a water inlet port, an air exhaust port, a plurality of water spouts, and a peripheral air inlet port. The showerhead assembly is configured to be manually lifted from the support frame, thereby functioning as a removable access panel for a space above the ceiling structure. This may provide both shower functionality and service access through a common ceiling-mounted assembly.

In a possible implementation form, the support frame further comprises an up-side-down step on a lower perimeter, the step having a height corresponding to a thickness of the ceiling structure, such that a bottom surface of the support frame is substantially coplanar with a bottom surface of the ceiling structure when installed. This may provide a more flush and integrated installed appearance.

In a possible implementation form the showerhead assembly comprises a top cover, a diaphragm, and a shower plate. This may provide a modular structure for defining separate internal flow paths.

In a possible implementation form the peripheral air inlet port is formed by a gap between an outer wall of the showerhead assembly and an inner wall of the through-hole of the support frame. This may allow air or humid air to enter the system around the perimeter of the showerhead assembly.

In a possible implementation form the peripheral air inlet port is further defined by slanted outer walls of the showerhead assembly and corresponding slanted inner walls of the through-hole of the support frame. This may help guide airflow into the apparatus.

In a possible implementation form the bottom surfaces of the showerhead assembly and the support frame are substantially coplanar when the assembly is resting on the support frame. This may improve the aesthetic integration of the installed system.

In a possible implementation form the support frame and the showerhead assembly each have a substantially orthogonal platform shape with rounded corners. This may simplify installation and provide a visually uniform appearance.

According to a third aspect the above and further aspects and advantages are obtained by an apparatus. In one embodiment the apparatus is a handheld showerhead and air-ventilation apparatus that includes a handle configured to be held by a user and to receive a supply of water from a water supply hose. A showerhead body is coupled to the handle. The showerhead body includes a water distribution chamber in fluid communication with the handle; a plurality of water spouts in fluid communication with the water distribution chamber; an air inlet port for receiving ambient humid air; and an air exhaust chamber in fluid communication with the air inlet port; and an air hose, separate and distinct from the water supply hose, coupled to the showerhead body and in fluid communication with the air exhaust chamber. The air hose is configured to discharge the humid air to a separate ventilation system. This may allow a user-positionable showerhead to also provide localized humid air extraction.

In a possible implementation form the air inlet port is located on one or more sides of the showerhead body. This may facilitate intake of humid air adjacent a user during handheld use.

In a possible implementation form the air hose is a flexible hose. This may improve ease of movement and routing during use.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the aspects of the disclosed embodiments will be explained in more detail with reference to the example embodiments shown in the drawings, in which:

FIG. 1 is a perspective section view of the assembled showerhead and air-ventilation apparatus, illustrating water and air pathways.

FIG. 2 is a perspective section view of the apparatus installed in a pre-cut opening in a bathroom ceiling.

FIG. 3 is a side section view of the installed apparatus, further illustrating the water and air pathways.

FIG. 4 is a partially exploded perspective view showing placement of the showerhead assembly, support frame, and ceiling opening prior to installation.

FIG. 5 is an exploded perspective view showing installation of the support frame in the ceiling opening.

FIG. 6 is a perspective view showing the fully installed apparatus with the showerhead assembly resting on the support frame.

FIG. 7 is a perspective view of the showerhead with the shower plate removed, showing water distribution and an air flow path.

FIG. 8 is a top perspective view of the shower plate and support frame in installed positions, illustrating water and air flow paths.

FIG. 9 is an exploded perspective view from a bottom-left perspective, showing components of the ceiling-mounted embodiment.

FIG. 10 is an exploded perspective view from a top-left perspective, showing components of the ceiling-mounted embodiment.

FIG. 11 is a perspective view of the assembled showerhead and air-ventilation apparatus.

FIG. 12 is a perspective view of a first alternative embodiment incorporated into a wall-mounted design.

FIG. 13 is a perspective view of a second alternative embodiment incorporated into a wall-mounted design.

FIG. 14 is a perspective view of a third alternative embodiment incorporated into a handheld showerhead design.

FIG. 15 is a perspective section view of combination showerhead and air-ventilation apparatus incorporating aspects of the disclosed embodiments

### DETAILED DESCRIPTION OF THE DISCLOSED EMBODIMENTS

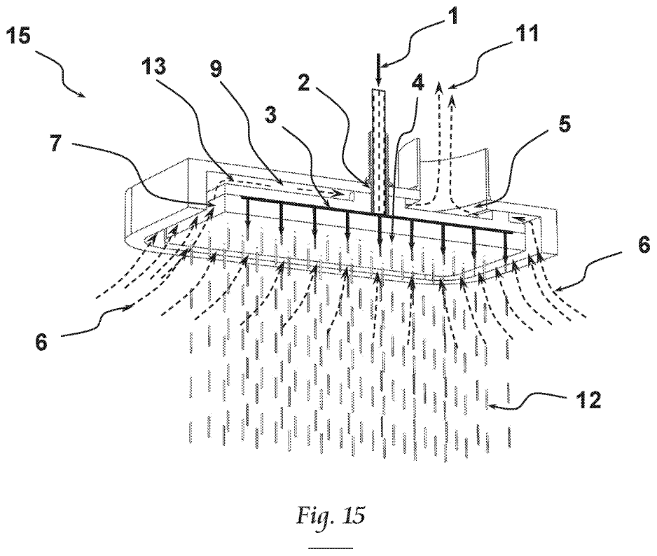

Referring to FIG. 15, the aspects of the disclosed embodiments are directed to a combination showerhead and air ventilation apparatus or device 15. The device 15 integrates water delivery and air extraction functions within a common apparatus, thereby enabling air, such as humid air 6, to be removed directly from a shower area while water 1 is delivered to a user. While the aspects of the disclosed embodiments are generally described herein with respect to humid air, the aspects of the disclosed embodiments are not so limited. Any type of air suitably found in a shower area is contemplated, other than including humid air.

Referring to the example of FIG. 15, the apparatus 15 includes a housing comprising a water inlet port 2, an air inlet port 7, a plurality of water spouts 4, and an air exhaust port 5. A water distribution chamber 3 is disposed within the housing and is configured to receive water 1 from the water inlet port 2 and distribute the water 1 to the plurality of water spouts 4. An air exhaust chamber 9 is also disposed within the housing and is configured to receive air 6 from the air inlet port 7 and direct the air 6 to the air exhaust port 5. The water distribution chamber 3 and the air exhaust chamber 9 are fluidly isolated from one another within the housing.

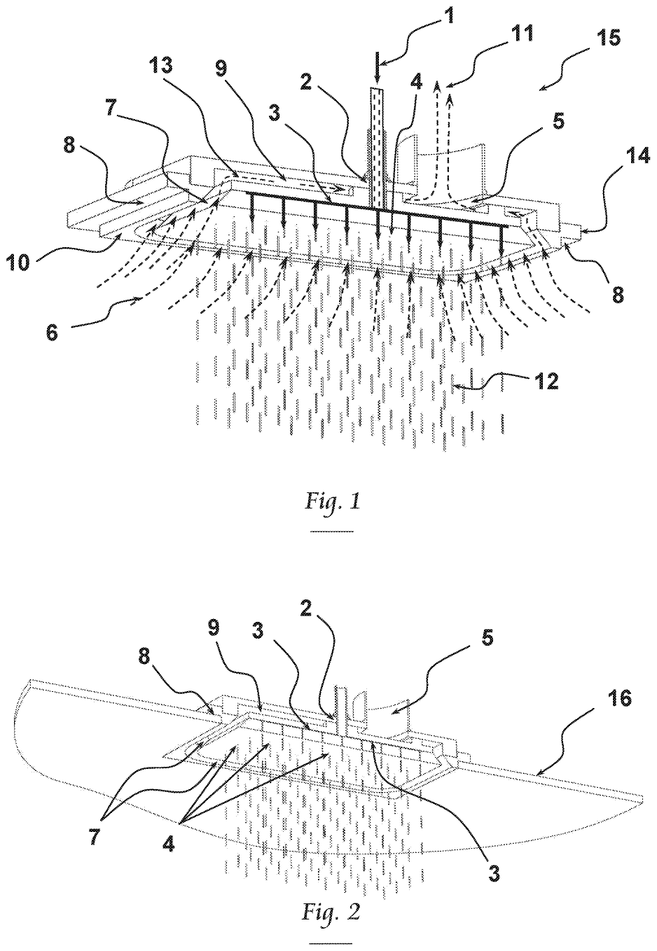

In the illustrated embodiment of FIG. 1-11, the apparatus 15 is configured as a ceiling-mounted unit. The apparatus 15 generally comprises a showerhead assembly 17 and a support frame 14. The showerhead assembly 17 is configured to provide a water spray 12 to a user while also receiving humid air 6 from the surrounding shower area and directing the humid air 6 away from the shower area through a separate internal air pathway. In this manner, the apparatus 15 may provide both showerhead and ventilation functionality in a common ceiling-mounted structure.

As shown in FIG. 2-6, the support frame 14 is configured for installation within a pre-cut opening 20 formed in a ceiling structure 16, such as a bathroom ceiling. In the illustrated embodiment, the support frame 14 includes an inverted step 8 disposed along a lower perimeter thereof. The inverted step 8 may have a height corresponding generally to a thickness of the ceiling structure 16 such that, when installed, the support frame 14 is received in a substantially flush manner relative to the visible ceiling surface. The support frame 14 may be secured to the ceiling structure 16 by screws, brackets, clips, adhesives, or any other suitable fastening arrangement.

The support frame 14 further includes an inner support region configured to receive and support the showerhead assembly 17. In the illustrated embodiment, the showerhead assembly 17 removably rests on the support frame 14 such that the showerhead assembly 17 may be manually lifted or removed from the support frame 14. In this manner, the apparatus 15 may also function as a removable ceiling access panel that provides access to a space above the ceiling structure 16 for plumbing, ducting, wiring, maintenance, or other utility access.

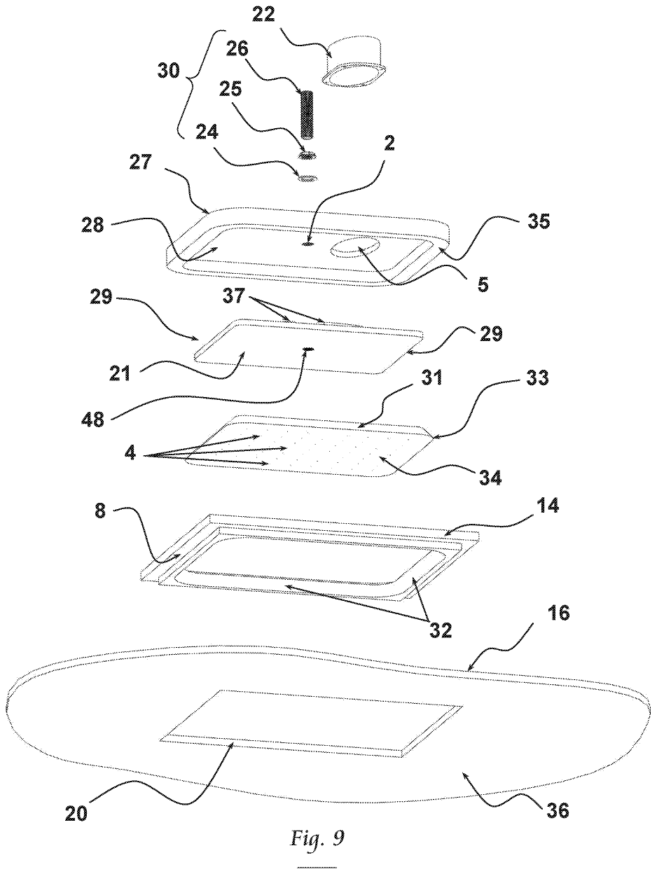

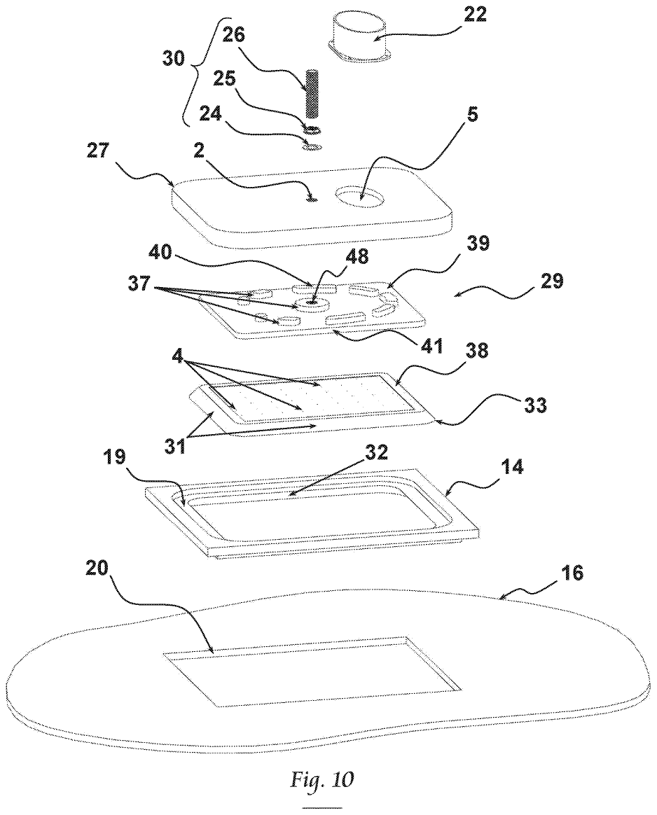

Referring to FIGS. 9 and 10, the showerhead assembly 17 comprises a top cover 27, a diaphragm 29, and a shower plate 33 arranged in a stacked configuration. These components cooperate to define a water flow path and an air ventilation path that remain fluidly isolated from one another while sharing a common external housing arrangement.

The top cover 27 forms an upper portion of the showerhead assembly 17. In the illustrated embodiment, the top cover 27 includes the water inlet port 2 and the air exhaust port 5. The water inlet port 2 is configured to receive incoming water 1 and may be coupled to a water supply fitting 30. In the illustrated embodiment, the water supply fitting 30 may include an externally threaded tube 26, a hex nut 25, and a washer 24, although other water supply connection structures may also be used. The air exhaust port 5 is configured to discharge exhaust air 11 and may be coupled to an air spigot 22, duct, hose, or other ventilation conduit.

The top cover 27 further includes an inverted pocket formed in a lower surface thereof. The inverted pocket extends upwardly into the body of the top cover 27 and provides an internal cavity region that accommodates at least part of the diaphragm 29 and defines a portion of the air exhaust chamber 9. The top cover 27 may have a generally orthogonal platform shape with rounded corners, as illustrated, although the top cover 27 may alternatively have any suitable planform shape, including circular, oval, polygonal, faceted, or ornamental shapes.

The diaphragm 29 is positioned below the top cover 27 and, in the illustrated embodiment, is received at least partially within the inverted pocket of the top cover 27. The diaphragm 29 includes a diaphragm plate 41 and a plurality of upwardly extending support columns 37 disposed on an upper surface of the diaphragm plate 41. The support columns 37 extend upward toward the lower surface of the top cover 27 and contact the lower surface of the top cover 27 when the showerhead assembly 17 is assembled. In this manner, the support columns 37 maintain a separation distance between the diaphragm plate 41 and the top cover 27.

The separation maintained between the diaphragm plate 41 and the top cover 27 defines the air exhaust chamber 9. Because the support columns 37 occupy only part of the available volume, open regions remain between adjacent support columns 37, thereby permitting airflow through the air exhaust chamber 9 toward the air exhaust port 5. The support columns 37 may have any suitable number, shape, spacing, and arrangement. For example, the support columns 37 may be cylindrical, rib-like, rectangular, lattice-like, or otherwise configured to provide structural support while preserving airflow through the air exhaust chamber 9.

Referring to FIG. 10, in the illustrated embodiment, the diaphragm 29 further includes a water passage 48, aligned with the water inlet port 2 of the top cover 27. The water passage 48 allows incoming water 1 to pass downward through the diaphragm 29 while maintaining fluid isolation between the water distribution chamber 3 and the air exhaust chamber 9. The diaphragm 29 therefore serves both as a structural support component and as a separator between the water flow path and the air ventilation path.

The shower plate 33 is positioned below the diaphragm 29 and forms a lower portion of the showerhead assembly 17. The shower plate 33 includes a top surface 38 and a bottom surface 34. In the illustrated embodiment, the top surface 38 includes a recessed pocket or cavity that, when enclosed by the bottom surface of the diaphragm 29, defines the water distribution chamber 3. Incoming water 1 received through the water inlet port 2 and water passage 48 is delivered into the water distribution chamber 3 for lateral distribution before discharge through the water spouts 4.

The bottom surface 34 of the shower plate 33 includes a plurality of openings defining the water spouts 4. The water spouts 4 may be arranged in any suitable pattern and may have any suitable geometry, including circular, slotted, polygonal, nozzle-shaped, elastomer-lined, or other outlet configurations. In some embodiments, one or more of the water spouts 4 may include flexible silicone or rubber sprinkler heads or anti-clog spray elements. The water spouts 4 may be configured to provide a rain shower spray 12, mist spray, massage spray, aerated spray, or any other desired water discharge pattern.

The shower plate 33 may be coupled to the diaphragm 29 by adhesive bonding, ultrasonic welding, thermal welding, snap-fit engagement, mechanical fasteners, or any other suitable joining arrangement. Likewise, the diaphragm 29 may be coupled to the top cover 27 by any suitable joining arrangement. In some embodiments, one or more seals, gaskets, O-rings, sealants, or compressible sealing members may be positioned between mating surfaces to preserve fluid isolation between the water distribution chamber 3 and the air exhaust chamber 9.

Referring particularly to FIGS. 1, 3, 7, and 8, the apparatus 15 defines two distinct internal pathways, namely a water flow path and an air ventilation path. The water flow path begins with incoming water 1 entering the water inlet port 2, passing through the water passage 48 of the diaphragm 29, and entering the water distribution chamber 3. The water 1 is then distributed laterally within the water distribution chamber 3 and discharged downward through the plurality of water spouts 4 as a shower spray 12.

The air ventilation path begins with humid air 6 entering the air inlet port 7. In the illustrated ceiling-mounted embodiment, the air inlet port 7 is defined as a peripheral gap extending around at least part of the showerhead assembly 17. More particularly, the air inlet port 7 may be formed between outer lateral surfaces of the showerhead assembly 17, including outer surfaces of the shower plate 33 and/or diaphragm 29, and surrounding inner surfaces of the support frame 14 and/or top cover 27. In this manner, humid air 6 may be drawn into the apparatus 15 around a perimeter of the showerhead assembly 17.

After entering the air inlet port 7, the humid air 6 follows an internal air path 13 into the air exhaust chamber 9. Once within the air exhaust chamber 9, the humid air 6 is directed toward the air exhaust port 5 and discharged as exhaust air 11 through a connected ventilation system. In some embodiments, the air exhaust port 5 may be coupled to an active air pressure deficit generating system, such as an exhaust fan, blower, inline fan, impeller assembly, suction source, or other air moving system, to facilitate active removal of humid air 6 from the shower area. In other embodiments, passive draft or remote building ventilation systems may be used.

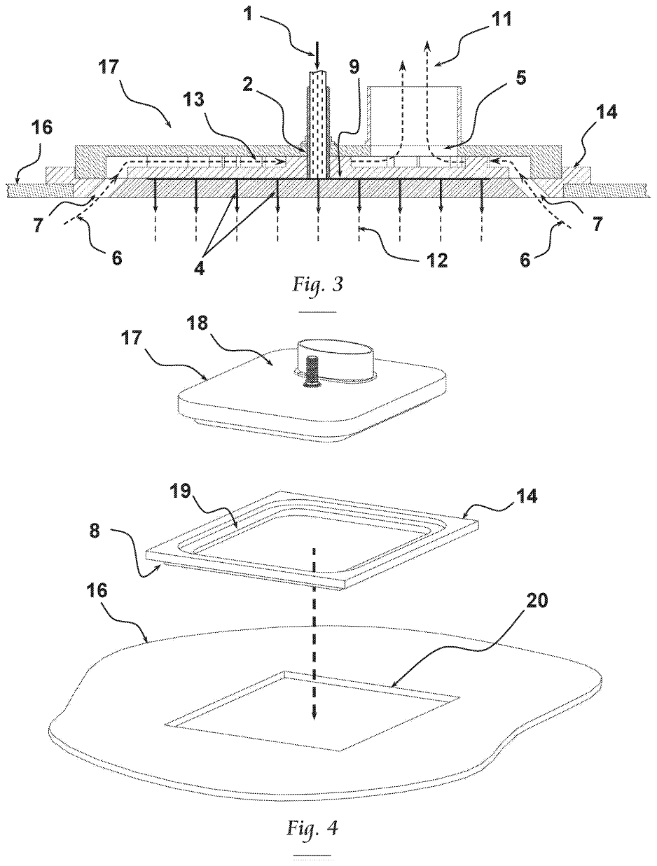

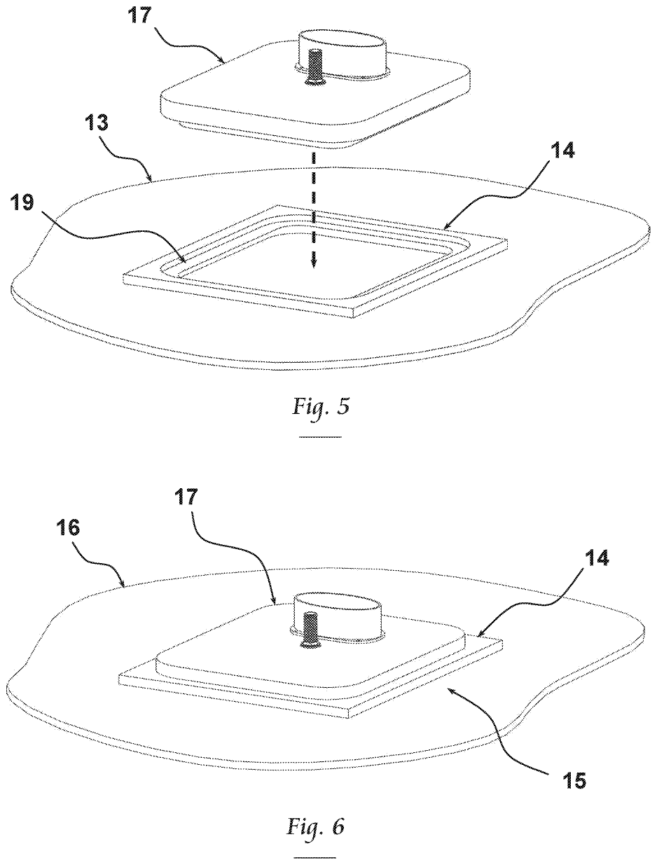

FIG. 1 illustrates the assembled showerhead and air-ventilation apparatus 15 in operation and shows both the water flow path and the air ventilation path. FIG. 2 illustrates the apparatus 15 installed in the ceiling structure 16. FIG. 3 further illustrates the installed configuration in section and shows the relative separation of the water and air pathways. FIG. 4 illustrates a partially exploded installation view showing the relative positioning of the showerhead assembly 17, support frame 14, and ceiling opening 20 prior to installation. FIG. 5 illustrates placement of the support frame 14 into the ceiling opening 20. FIG. 6 illustrates the fully installed apparatus 15 with the showerhead assembly 17 resting on the support frame 14.

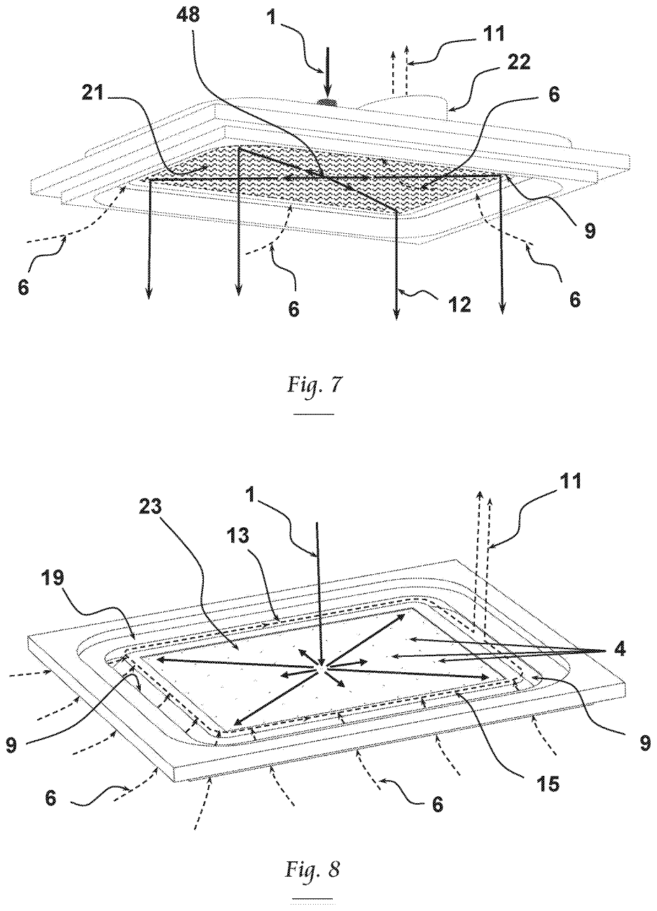

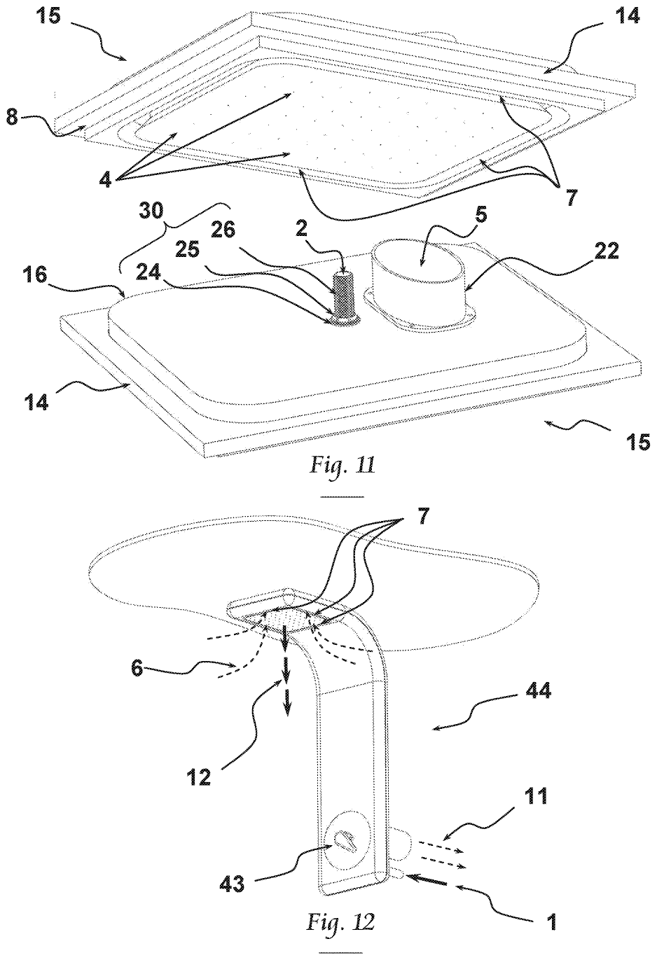

FIG. 7 illustrates the showerhead assembly 17 with the shower plate 33 removed, thereby showing internal structural features associated with the water distribution chamber 3 and air exhaust chamber 9. FIG. 8 illustrates the relative positioning of the shower plate 33 and support frame 14 and further illustrates the paths of water 1 and humid air 6. FIGS. 9 and 10 illustrate exploded views of the components of the ceiling-mounted embodiment, including the top cover 27, diaphragm 29, shower plate 33, support frame 14, ceiling opening 20, and associated connection components. FIG. 11 illustrates the fully assembled apparatus 15.

In some embodiments, the apparatus 15 may further include one or more additional functional components. For example, the apparatus 15 may include an integrated light fixture, one or more LEDs, a speaker, a fragrance dispensing feature, a dehumidifying feature, an integrated water filter, a soap dispensing feature, one or more sensors, a controller, or any other suitable auxiliary component. Such components may be incorporated into or supported by the top cover 27, diaphragm 29, shower plate 33, support frame 14, or associated plumbing or ventilation structures.

The components of the apparatus 15 may be formed from polymeric materials, metallic materials, composite materials, elastomeric materials, ceramic materials, or combinations thereof. By way of example only, the top cover 27, diaphragm 29, shower plate 33, and support frame 14 may be molded, machined, cast, thermoformed, additively manufactured, or otherwise fabricated. The disclosed embodiments are not limited to any particular manufacturing process or material selection.

Although the illustrated ceiling-mounted embodiment uses a top cover 27, a diaphragm 29, and a shower plate 33 as separate components, the inventive concept is not limited to a three-piece showerhead assembly. In some embodiments, two or more of these functional portions may be integrated into fewer parts. For example, the top cover 27 and diaphragm 29 may be formed as a single unitary upper component, and the shower plate 33 may be joined directly thereto. In such embodiments, internal cavities, pockets, ribs, partitions, or channels formed in one or more mating surfaces may still define the water distribution chamber 3 and the air exhaust chamber 9 while maintaining fluid isolation between the water flow path and the air ventilation path.

Likewise, while the illustrated ceiling-mounted embodiment employs a peripheral air inlet port 7, the air inlet port 7 may take many different forms. For example, the air inlet port 7 may be continuous or discontinuous, annular, segmented, ring-shaped, grille-shaped, perforated, slotted, or otherwise configured to receive humid air 6 from the shower area. The air inlet port 7 may additionally or alternatively be located on one or more top, bottom, side, front, rear, or peripheral surfaces depending on the intended mounting arrangement and airflow design.

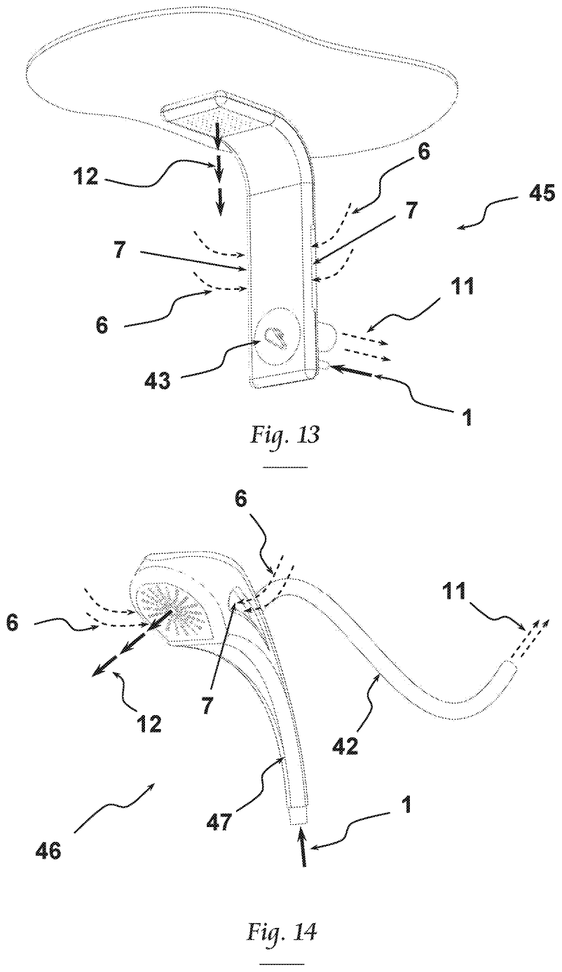

Referring now to FIGS. 12 and 13, the inventive concept may also be implemented in wall-mounted embodiments 44 and 45. In these embodiments, the showerhead and air-ventilation functions are incorporated into a wall-mounted housing that may optionally be associated with a mixer valve 43 or other plumbing control assembly. Incoming water 1 may be supplied from behind the wall and delivered into the wall-mounted unit, while exhaust air 11 may also be discharged rearwardly or laterally through wall-connected ventilation components.

In the wall-mounted embodiment 44 illustrated in FIG. 12, the air inlet port 7 is located near an upper region of the housing so as to receive humid air 6 rising from the shower area. In the wall-mounted embodiment 45 illustrated in FIG. 13, the air inlet port 7 is positioned on one or more side regions of the housing. In other wall-mounted embodiments, the air inlet port 7 may additionally or alternatively be positioned on a lower region, front face, rear region, top face, bottom face, or combinations thereof. The water inlet port 2 and air exhaust port 5 may be located on a rear surface of the housing for fluid connection through a wall cavity.

Referring now to FIG. 14, the inventive concept may further be implemented in a handheld showerhead embodiment 46. In this embodiment, the apparatus includes a handle 47 coupled to a showerhead body or housing. Water 1 may be supplied through the handle 47, such as through a conventional water supply hose, and delivered into an internal water distribution chamber for discharge through water spouts 4. Humid air 6 may be received through one or more air inlet ports 7 positioned on one or more side regions of the showerhead body, and the humid air 6 may be directed through an internal air exhaust chamber toward an air exhaust port coupled to a separate air hose 42.

In the handheld embodiment 46, the air hose 42 may be flexible and separate from the water supply hose, thereby allowing the handheld apparatus to remain movable while still providing humid air extraction. In some handheld embodiments, the air inlet port 7 may be located on one or more side surfaces, top surfaces, bottom surfaces, or combinations thereof to facilitate local intake of humid air 6 during use.

Although several embodiments are described herein with reference to specific structural arrangements, the disclosed concepts are not limited to the exact configurations shown. Dimensions, proportions, geometries, materials, fastening arrangements, port positions, chamber configurations, airflow paths, water distribution structures, and mounting arrangements may all be modified while still employing the inventive concept of integrating showerhead water delivery and humid air extraction within a common apparatus. Accordingly, all suitable modifications, combinations, subcombinations, equivalents, and alternatives are intended to fall within the scope of the present disclosure.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A combination showerhead and air-ventilation apparatus, comprising:
a housing comprising a water inlet port, an air inlet port, a plurality of water spouts, and an air exhaust port;
a water distribution chamber disposed in the housing and configured to receive water from the water inlet port and distribute the water to the plurality of water spouts; and
an air exhaust chamber disposed in the housing and configured to receive air from the air inlet port and direct the air to the air exhaust port,
wherein the water distribution chamber and the air exhaust chamber are fluidly isolated from one another within the housing.

2. The apparatus of claim 1, further comprising an air pressure deficit generating system in fluid communication with the air exhaust port.

3. The apparatus of claim 1, wherein the housing comprises a top cover, a diaphragm, and a shower plate, and wherein the air exhaust chamber is defined between the top cover and the diaphragm, the diaphragm separating the air exhaust chamber from the water distribution chamber.

4. The apparatus of claim 3, wherein the water distribution chamber is defined between the diaphragm and the shower plate.

5. The apparatus of claim 3, wherein the air inlet port comprises a peripheral gap defined between outer lateral walls of the diaphragm and the shower plate and inner lateral walls of the top cover.

6. The apparatus of claim 3, wherein the diaphragm comprises a diaphragm plate and a plurality of support columns extending from a top surface of the diaphragm plate to a bottom surface of the top cover, the plurality of support columns spacing the diaphragm plate from the top cover to define the air exhaust chamber.

7. The apparatus of claim 6, wherein the water distribution chamber is defined by a recessed pocket formed on a top surface of the shower plate, the recessed pocket being enclosed by a bottom surface of the diaphragm.

8. The apparatus of claim 1, wherein the apparatus is a ceiling-mounted unit, and wherein the water inlet port and the air exhaust port are located on a top surface of the housing.

9. The apparatus of claim 8, further comprising a support frame configured for installation in a ceiling, the support frame including an inner step on which the housing removably rests such that the apparatus is removable from the support frame to provide ceiling access.

10. The apparatus of claim 9, wherein the support frame includes an inverted step along a lower perimeter thereof, the inverted step having a height corresponding to a thickness of a ceiling panel.

11. The apparatus of claim 1, wherein the apparatus is a wall-mounted unit.

12. The apparatus of claim 11, wherein the water inlet port and the air exhaust port are located on a rear surface of the housing and are configured for fluid connection through a wall.

13. The apparatus of claim 11, wherein the air inlet port is located on at least one of a top surface, a bottom surface, or a side surface of the housing.

14. The apparatus of claim 1, wherein the apparatus is a handheld unit further comprising a handle coupled to the housing.

15. The apparatus of claim 14, wherein the water inlet port is configured to receive water through the handle.

16. The apparatus of claim 14, wherein the air exhaust port is connected to a flexible air hose.

17. The apparatus of claim 16, wherein the air inlet port is located on a side surface of the housing.

18. The apparatus of claim 1, further comprising an integrated light fixture.

19. The apparatus of claim 1, further comprising an integrated water filter disposed within the water distribution chamber or upstream thereof.

20. The apparatus of claim 1, further comprising an integrated soap dispensing feature.
